(19) United States
(12) Patent Application Publication
(10) Pub. No.: US 2024/0246440 A1
(43) Pub. Date: Jul. 25, 2024

(54) Control Strategy for Scheduling Electrified Vehicle Charging

(71) Applicant: Ford Global Technologies, LLC, Dearborn, MI (US)

(72) Inventors: Stuart Salter, White Lake, MI (US); Brendan Diamond, Grosse Pointe, MI (US); Ryan O'Gorman, Beverly Hills, MI (US); Timilehin Ogunbekun, Southfield, MI (US); Pietro Buttolo, Dearborn Heights, MI (US); Annette Lynn Huebner, Highland, MI (US)

(73) Assignee: Ford Global Technologies, LLC, Dearborn, MI (US)

(21) Appl. No.: 18/099,413

(22) Filed: Jan. 20, 2023

(51) Int. Cl. B60L 53/62; B60L 53/63

(52) U.S. Cl. CPC B60L 53/62; B60L 53/63; B60L 2240/545; B60L 2240/60; G01C 21/3476

(57) ABSTRACT

A vehicle includes a traction battery and a controller. The controller, in response to the traction battery having to be charged at a charging station during a vehicle trip for the traction battery to have sufficient energy for the vehicle to complete the vehicle trip, schedules the traction battery for charging during the vehicle trip at a selected charging station from among multiple charging stations in which an overall time of the vehicle trip will be lowest.

### TECHNICAL FIELD

The present disclosure relates to charging an electrified vehicle at one or more charging stations during a vehicle trip between an origin and a destination.

### BACKGROUND

An electrified vehicle includes a traction battery for providing power to a motor of the vehicle to propel the vehicle. The traction battery is rechargeable at charging stations.

### SUMMARY

An electrified vehicle having a traction battery and a controller is provided. The controller is configured to, in response to the traction battery having to be charged at a charging station during a trip for the traction battery to have sufficient energy for the vehicle to complete the trip, schedule the traction battery for charging during the trip at a selected charging station from among multiple charging stations in which an overall time of the trip will be lowest.

The controller may detect that the overall time of the trip will be lowest with the battery being charged at the selected charging station based on a predicted temperature that the battery will have when being charged during the trip at the selected charging station.

The controller may, upon the battery being scheduled for charging during the trip at the selected charging station, implement a drive route for the vehicle to be driven to the selected charging station.

The selected charging station may be closer to a destination of the trip than at least another charging station of the multiple charging stations. The selected charging station may have a charge rate capability lower than a charge rate capability of at least another charging station of the multiple charging stations. A distance of an origin of the trip to the selected charging station to a destination of the trip may be greater than a distance of the origin of the trip to at least another charging station of the multiple charging stations to the destination of the trip.

The controller may detect the overall time of the trip that would exist with charging the battery during the trip at the selected charging station as being a summation of (i) a drive time for driving the vehicle from an origin of the trip to the selected charging station and from the selected charging station to a destination of the trip and (ii) a charge time for charging the battery during the trip at the selected charging station.

The controller may predict a temperature that the battery will have when being charged during the trip at the selected charging station. In this case, the controller may estimate a charge rate at which the battery will be charged during the trip at the selected charging station based on the temperature that the battery will have when being charged during the trip at the selected charging station and detect the charge time for charging the battery during the trip at the selected charging station based in part on the charge rate at which the battery will be charged during the trip at the selected charging station. Further in this case, the controller may estimate a charge amount that the battery is to be charged with when being charged during the trip at the selected charging station, the charge amount being sufficient for the battery to have at least sufficient energy for the vehicle to be driven from the selected charging station to the destination; and detect the charge time for charging the battery during the trip at the selected charging station further based on the charge amount that the battery is to be charged with when being charged during the trip at the selected charging station.

The controller may estimate for each charging station the overall time of the trip that would exist with the battery being charged at that charging station to detect therefrom that the overall time of the trip is lowest with the battery being charged at the selected charging station. In this case, the controller may estimate for each charging station the overall time of the trip that would exist with the battery being charged at that charging station based on a predicted temperature that the battery would have when being charged during the trip at that charging station. Alternatively in this case, the controller may estimate for each charging station the overall time of the trip that would exist with the battery being charged at that charging station as being a summation of (i) a drive time for driving the vehicle from an origin of the trip to that charging station and from the that charging station to a destination of the trip and (ii) a charge time for charging the battery during the trip at that charging station. Alternatively in this case, the controller may predict for each charging station a temperature that the battery would have when being charged during the trip at that charging station and estimate for each charging station the charge time for charging the battery during the trip at that charging station based on the temperature that the battery would have when being charged during the trip at that charging station.

A system having a controller is provided. The controller, in response to a traction battery of a vehicle having to be charged at a charging station during a vehicle trip for the traction battery to have sufficient energy for the vehicle to complete the trip, schedules the traction battery for charging during the vehicle trip at a selected charging station from among multiple charging stations along one or more drive routes between an origin of the vehicle trip and a destination of the vehicle trip in which an overall time of the vehicle trip is the lowest, the overall time being a summation of (i) a drive time for the vehicle to be driven from the origin to the selected charging station to the destination and (ii) a charge time for the traction battery to be charged during the vehicle trip at the selected charging station.

A method for a vehicle having a traction battery is provided. The method includes detecting that the traction battery will have to be charged at a charging station during a trip for the traction battery to have sufficient energy for the vehicle to complete the vehicle trip. The method further includes scheduling the traction battery for charging during the vehicle trip at a selected charging station from among multiple charging stations in which an overall time of the vehicle trip is lowest.

### BRIEF DESCRIPTION OF THE DRAWINGS

FIG. 1 illustrates a block diagram of a battery electric vehicle (BEV) having a traction battery;

FIG. 2 illustrates an exemplary map showing locations of charging stations in a geographic area, the geographic area being the eastern region of South Dakota; and

FIG. 3 illustrates a flowchart describing operation of a control strategy implemented with use by a controller of the BEV for scheduling charging of the BEV.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The present disclosure describes a control strategy for scheduling charging of a traction battery of an electrified vehicle at one or more charging stations during a vehicle trip between an origin of the vehicle and a destination of the vehicle. The charging of the traction battery is required as the vehicle otherwise does not have enough range to complete the vehicle trip. The control strategy scheduling prioritizes minimizing the overall time of the vehicle trip. The control strategy scheduling takes into consideration the temperature of the traction battery during the vehicle trip in order to minimize the overall time of the vehicle trip.

The overall time of the vehicle trip includes the drive time and the charge time (i.e., overall time=drive time+charge time). The drive time is the time spent during which the vehicle is being driven between the origin and the destination. The charge time (or charge duration) is the time spent during which the traction battery is being charged at a charging station. The charge time for charging the traction battery at a charging station is dependent on the amount of charge current (i.e., the charge amount) provided by the charging station to the traction battery and the charge rate at which the charging station provides the charge current to the traction battery (i.e., charge time=charge amount*charge rate). The charge amount depends on the difference between a state-of-charge (SOC) of the traction battery at the end of charging and a SOC of the traction battery at the beginning of charging (i.e., SOC_{end}-SOCₛₜₐᵣₜ). The charge rate depends on the temperature of the traction battery with the charge rate being substantially reduced at relatively cold temperatures (e.g., below 0 F°) of the traction battery. As such, typically, at relatively cold temperatures, the temperature of the traction battery is the limiting factor for the charge time.

As an example, for a vehicle trip between an origin and a destination in which the vehicle is scheduled to be charged at just one charging station, the drive time is the time that is spent for the vehicle to be driven from the origin to the charging station and from the charging station to the destination, and the charge time is the time that is spent for the traction battery to be charged at the charging station. In this case, as minimizing the overall time of the vehicle trip is prioritized, the distance driven during the vehicle trip could be longer than the distance that would have been driven had a different charging station located more along the drive route between the origin and the destination been scheduled. That is, in prioritizing minimizing the overall time of the vehicle trip, the control strategy may schedule a charging station that is somewhat out-of-the-way of the drive route in lieu of scheduling a charging station located more inline along the drive route. The out-of-the-way charging station would be scheduled as its relatively faster charge time more than compensates for the relatively longer drive time required to drive from the origin to this charging station and from this charging station to the destination.

Lastly, a practical situation in which the control strategy for scheduling charging of the traction battery is employed is when the destination is the vehicle user's home. In this case, once the vehicle has arrived at the user's home, the vehicle user can charge the traction battery such as overnight for use the next day. Accordingly, in this case, during the vehicle trip, the traction battery may just be charged enough with sufficient margin for the vehicle to have enough range to arrive at the user's home.

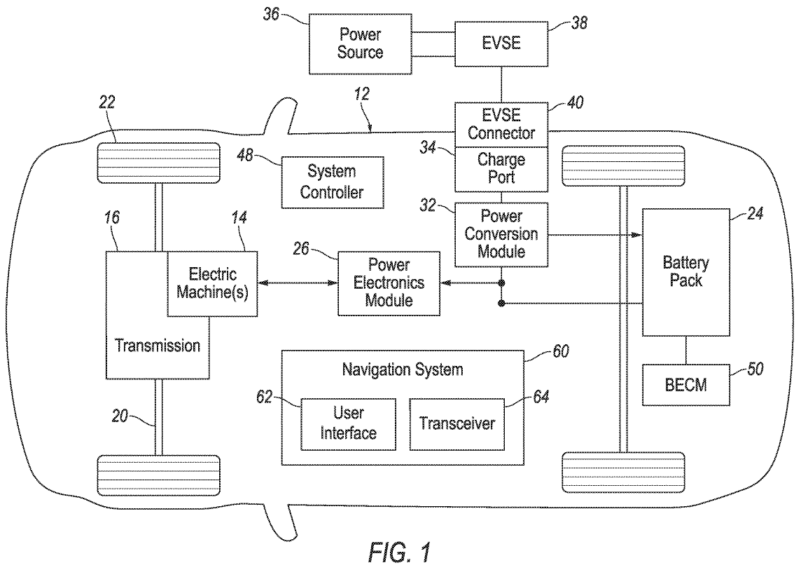

Referring now to FIG. 1, a block diagram of an electrified vehicle 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all of the propulsion power and the vehicle does not have an engine. In other embodiments, the vehicle may be a plug-in hybrid electric vehicle (PHEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and is capable of operating as a generator. Traction motor 14 acting as a generator can recover energy that may normally be lost as heat in a friction braking system of BEV 12.

Traction battery 24 stores electrical energy that can be used by traction motor 14 for propelling BEV 12. Traction battery 24 typically provides a high-voltage (HV) direct current (DC) output. Traction battery 24 may be a lithium-ion battery. Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV such as HV loads like fan, electric heater, and air-conditioner systems and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 may be part of a charging station. The charging station may be publicly accessible such as being located on the premises of a commercial building, public parking garage, hospital, school, etc., or may be privately accessible such as being located in the garage of the vehicle user's home. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12. Alternatively, EVSE 38 may be configured to provide wireless charging.

A power conversion module 32 of BEV 12, such as an on-board charger having a DC/DC converter, may condition power supplied from EVSE 38 to provide the proper voltage and current levels to traction battery 24. Power conversion module 32 may interface with EVSE 38 to coordinate the delivery of power to traction battery 24. Power conversion module 32 may control when charging begins at the charging station of EVSE 38, the length of charging, the power levels of charging, etc.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. In embodiments, controller 48 is a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating parameters of traction battery 24. BECM 50 may implement algorithms to measure and/or estimate the operating parameters of traction battery 24. BECM 50 controls the operation and performance of traction battery 24 based on the operating parameters of the traction battery.

The operating parameters of traction battery 24 include the temperature, the charge capacity, and the SOC of the traction battery. For reference, the charge capacity of traction battery 24 is indicative of the amount of electrical energy that the traction battery may store. The SOC of traction battery 24 is indicative of a present amount of electrical energy stored in the traction battery. The SOC of traction battery 24 may be represented as a percentage of a maximum amount of electrical energy that may be stored in the traction battery. Traction battery 24 may also have corresponding charge and discharge power limits that define the amount of electrical power that may be supplied to or by the traction battery at a given time.

Traction battery 24 may have one or more temperature sensors such as thermistors in communication with BECM 50 to provide data indicative of the temperature of battery cells of the traction battery for the BECM to monitor the temperature of the traction battery. BEV 12 may further include a temperature sensor to provide data indicative of ambient temperature for BECM 50 to monitor the ambient temperature.

BEV 12 further includes a navigation system 60. Navigation system 60 may include a global positioning system (GPS) and is operable for generating drive route information and monitoring the location of BEV 12 in relation to the drive route information. Navigation system 60 is further operable to identify the locations of various charging stations along the drive route and to obtain traffic information along the drive route and traffic information to the charging stations.

Navigation system 60 includes a user interface 62 located inside passenger cabin of BEV 12 for displaying a drive route and related information. A user of BEV 12 may interact with user interface 62 via a touch screen, buttons, audible speech, etc. The user may manually enter the drive route into navigation system 60 using user interface 62. Navigation system 60 may automatically infer the drive route based on historical data accumulated from prior drive routes the user has planned or traveled.

Navigation system 60 further includes a transceiver 64. Transceiver 64 is operable for communicating with charging stations located along and in the vicinity of the drive route. In this way, navigation system 60 can obtain information regarding the charge capability (e.g., fast charger, Level 1 or 2 charger, etc.) and availability of the charging stations. Further, navigation system 60 can make an appointment with one or more of the charging stations to schedule charging of BEV 12 at appointed time(s) with the appointed charging station(s).

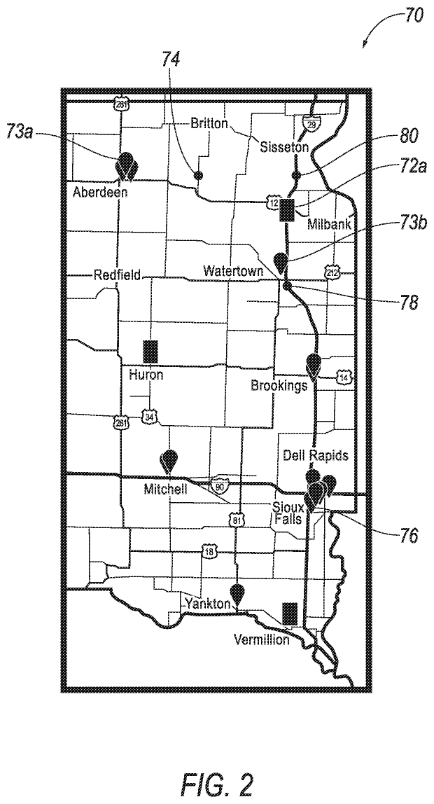

Referring now to FIG. 2, an exemplary map 70 is shown. Exemplary map 70 is a map of the eastern region of South Dakota. As is well understood, exemplary map 70 shows cities and towns and highways and roads. Exemplary map 70 further shows locations of publicly accessible charging stations (or “chargers”). In this regard, exemplary map 70 includes symbols 72 and 73 which designate the locations of publicly accessible charging stations. Symbols 72 and 73 have different shapes to designate different types of charging stations. Particularly, symbol 72 designates Level 2 charger charging stations and symbol 73 designates fast charger charging stations.

For reference, the types of charging stations are classified in part by their charge rate capabilities (i.e., the rate at which charge current at a designated voltage can be delivered by the charging station). A fast charger charging station can deliver charge current at a higher rate than a Level 2 charger charging station. For instance, a few minutes of charge time at a fast charge rate of the fast charger would deliver the same charge amount as an hour of charge time at a slow charge rate of a Level 2 charger.

Furthermore, as noted above, the charge rate of a charging station depends on the temperature of the traction battery being charged at the charging station with the charge rate being substantially reduced at relatively cold temperatures of the traction battery. Thus, it could take longer for a fast charger to charge a relatively cold traction battery than it would take for a Level 2 charger to charge a warm traction battery. That is, the fast charge rate of the fast charger is not applicable (i.e., substantially hindered) when the temperature of the traction battery is too cold.

As shown in exemplary map 70, a Level 2 charging station 72a is located in Milbank, a fast charger charging station 73a is located in Aberdeen, and a fast charger charging station 73b is located in Watertown.

With reference to exemplary map 70, controller 48 implementing the control strategy for scheduling charging of traction battery 24 at one or more of charging stations during a vehicle trip between an origin of the vehicle and a destination of the vehicle will now be described with a first example.

In this example, the origin 74 of the vehicle trip is at a location south of Britton and the destination 76 of the vehicle trip is at a location in Sioux Falls. As understood from exemplary map 70, the least drive distance for this vehicle trip would be to drive from origin 74 south to Highway 12 and along Highway 12 east to Milbank and from Milbank along Interstate 29 passing Watertown and Brookings to Sioux Falls with arrival at destination 76.

Further in this example, traction battery 24 does not have enough energy for BEV 12 to drive from origin 74 to destination 76 without being charged at a charging station. Thus, charging of traction battery 24 at a charging station along or in the vicinity of the drive route is required as BEV 12 otherwise does not have enough range to complete the vehicle trip. Particularly, traction battery 24 does not have energy for BEV 12 to drive from origin 74 to fast charger 73b in Watertown without being charged. Accordingly, in this example, assuming minimizing driving distance between origin 74 and destination 76 is prioritized as is conventionally the case, BEV 12 is driven from origin 74 to Level 2 charger 72a in Milbank for charging and then driven from Milbank to destination 76. (This example could be modified with some charging being done at Level 2 charging station 72a in Milbank followed by charging being done at fast charging station 73b in Watertown. The point is that in this example charging is required at Level 2 charging station 72a in Milbank when minimizing driving distance.)

Further in this example, it is assumed that traction battery 24 starts out with a relatively cold temperature at origin 74 and then has at least a warm temperature throughout the remainder of the vehicle trip. Hence, the temperature of traction battery 24 does not hinder the charge rate of any of the charging stations. Nevertheless, as Level 2 charging station 72a has a relatively slow charge rate, the overall time of the vehicle trip (comprised of a summation of the charge time at Level 2 charging station 72a and the drive time) is longer than what the overall time of the vehicle trip would have been had the charging been done instead at a fast charger.

The control strategy implemented by controller 48 for scheduling charging of traction battery 24 at one or more of the charging stations prioritizes minimizing the overall time of the vehicle trip. In minimizing the overall time of the vehicle trip, the control strategy takes into consideration the temperature of traction battery 24 during the vehicle trip.

Accordingly, in this example with the vehicle trip being from origin 74 to destination 76, in implementing the control strategy controller 48 schedules charging at fast charging station 73a in Aberdeen instead of at Level 2 charging station 72a in Milbank. In scheduling fast charging station 73a, controller 48 predicts that the temperature of traction battery 24 would be warm at fast charging station 73a so that the charge rate of fast charging station 73a would not be hindered. Controller 48 acknowledges that the driving distance would be increased with BEV 12 being driven from origin 74 along Highway 12 west to fast charging station 73a in Aberdeen for charging and then driven from Aberdeen along Highway 12 east to Milbank (as opposed to being directly driven from origin 74 to Level 2 charging station 72a in Milbank for charging) and from Milbank along Interstate 29 passing Watertown and Brookings to Sioux Falls with arrival at destination 76. Controller 48 thus takes into consideration that the drive time would also be increased with the increased driving distance due to driving to and from the out-of-the-way fast charging station 73a in Aberdeen. However, controller 48 estimates that the charge time using fast charging station 73a is less than the summation of (i) the charge time using Level 2 charging station 72a and (ii) the additional drive time due to driving to and from fast charging station 73a. As such, the overall time of the vehicle trip using the out-of-the-way fast charging station 73a in Aberdeen is less than the overall time of the vehicle trip using Level 2 charging station 72a in Milbank. Consequently, even though the driving distance is increased, the overall time of the vehicle trip is decreased with controller 48 implementing the control strategy.

As a second example, the origin 78 of a vehicle trip is at a location just south of Watertown and the destination 80 of the vehicle trip is at a location north of Milbank. The vehicle trip would be to drive from origin 78 north along Interstate 29 passing Milbank with arrival at destination 80. Further in this example, traction battery 24 starts out at origin 78 with almost enough energy, but not quite enough energy, for BEV 12 to be driven from origin 78 to destination 80 without being charged. As traction battery 24 does not start out with quite enough energy for completing the vehicle trip, the traction battery has to be charged at either fast charger 73b in Watertown or at Level 2 charger 72a in Milbank during the vehicle trip. Further in this example, it is assumed that traction battery 24 starts out with a relatively cold temperature at origin 78 and does not have a warm temperature until passing through Watertown. Hence, the temperature of traction battery 24 hinders the charge rate of fast charger 73b in the event that BEV 12 is driven directly from origin 78 to fast charger 73b but does not hinder the charge rate of Level 2 charger 72a.

In this example, the control strategy implemented by controller 48 schedules charging of traction battery 24, from among fast charger 73b and Level 2 charger 72a, at the charger in which the overall time of the vehicle trip will be minimized. In minimizing the overall time of the vehicle trip, the control strategy takes into consideration the temperature of traction battery 24 during the vehicle trip. Accordingly, in this example, controller 48 schedules charging at Level 2 charger 72a instead of at fast charger 73b. Controller 48 passes on fast charger 73b as the controller predicts that the temperature of traction battery 24 would be relatively cold at fast charger 73b so that the charge rate of fast charger 73a would be hindered. Correspondingly, in selecting Level 2 charger 72a, controller 48 predicts that the temperature of traction battery 24 would be at least warm at Level 2 charger 72a so that the charge rate of Level 2 charger 72a would not be hindered. Controller 48 further takes into consideration that the drive time would be the same regardless of which of charging stations 73a and 72a is scheduled.

Controller 48 further takes into consideration that the amount of charge current to be provided to traction battery 24 is a relatively small amount as the traction battery starts out with almost enough energy for BEV 12 to be driven from origin 78 to destination 80 without the traction battery being charged. That is, controller takes into consideration (i) the SOC that traction battery 24 will have at the beginning of charging at a charge station and (ii) the SOC that the traction battery 24 is to have at the end of charging at the charge station for BEV 12 to have enough range with given margin to drive to the next destination (in this example, the next destination being final destination 80).

In taking all of these factors into consideration, controller 48 selects Level 2 charge station 72a in Milbank for charging instead of selecting fast charge station 73b in Watertown. Particularly, controller 48 determines that the charge time for the requisite charge amount using Level 2 charger 72a is less than the charge time using fast charge station 73b (because of the warm temperature of the traction battery at Level 2 charge station 72a compared to the relatively cold temperature of the traction battery at fast charge station 73b) and that the drive time is the same for both charge stations 72a and 73b. Consequently, the overall time of the vehicle trip is lower with traction battery 24 being charged at Level 2 charger 72a than the overall time of the vehicle trip with the traction battery being charged at fast charge station 73b. (Controller 48 further determines that an alternative of instead driving around Watertown for traction battery 24 to be heated and then followed by charging at fast charger station 73b in Watertown would add too much additional drive time thereby resulting in an overall trip time greater than the overall trip time in simply driving directly to Level 2 charger 72a for charging.) Consequently, the overall time of the vehicle trip is decreased with controller 48 implementing the control strategy.

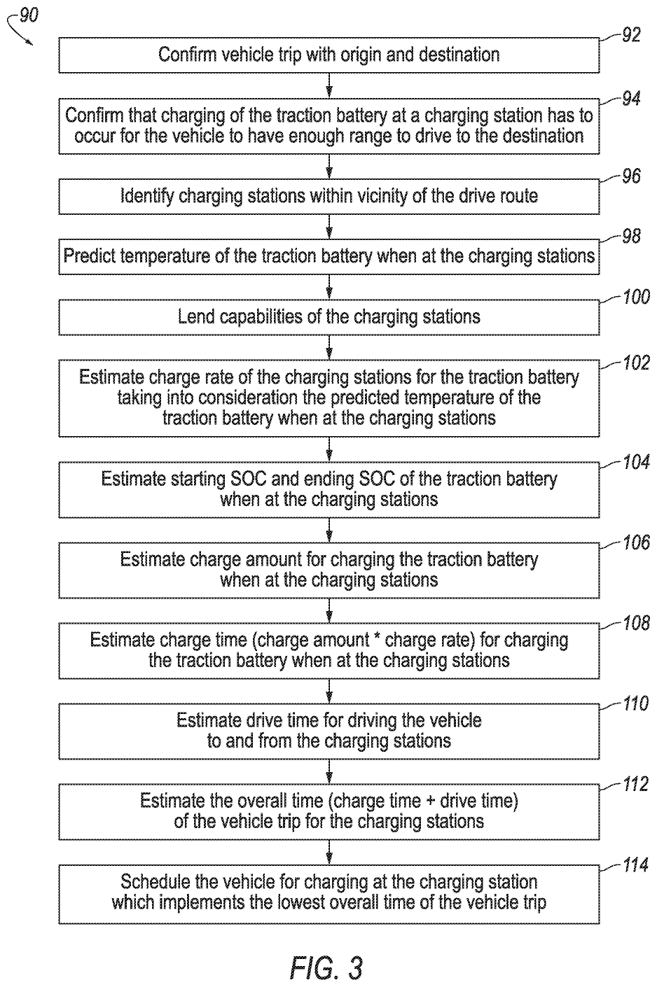

The control strategy for scheduling charging of traction battery 24 will now be described in further detail with reference to FIG. 3. FIG. 3 illustrates a flowchart 90 depicting operation of the control strategy. As described, the control strategy provides a charge time estimation and charge station sorting using a vehicle thermal assessment system. In this regard, the control strategy includes the steps (functions) illustrated in flowchart 90 and described below. The control strategy is implemented with the use of controller 48.

The operation begins with controller 48 confirming that BEV 12 is on (or will be on) a vehicle trip having a starting origin and a final destination, as indicated in process block 92. The operation continues with controller 48 confirming that traction battery 24 will have to be charged at a charging station during the vehicle trip for the BEV to have enough range to be driven to the final destination, as indicated in process block 94. Controller 48 with navigation system 60 identifies one or more drive routes for implementing the vehicle trip. The vehicle user may use user interface 62 of navigation system 60 to select one the drive routes.

The steps of process block 92 and process block 94 thus involve controller 48 confirming intent for traction battery 24 to be charged based on a route guidance system, user input, or other related information such as the diver's occupation (ridesharing, taxi, delivery, etc.) indicating a final location travel distance further than the vehicle range.

The operation further includes controller 48 in conjunction with navigation system 60 identifying charging stations within range of BEV 12 while still following the selected drive route, as indicated by process block 96. That is, the locations of charging stations within range of BEV 12 while still following the intended drive route (or intended vehicle function) are identified. Controller 48 stores these locations and, in working with navigation system 60, identifies the appropriate route metrics to each charging station. Further, filtering can be employed to narrow down to locations and distances from the current location of BEV 12 where charging is likely to occur. As examples, charging may be determined to likely occur such as at a mall, food location, coffee house, or a specified distance or time in the future for which, for example, twenty to eighty miles of range is remaining.

The operation further includes controller 48 predicting the temperature of traction battery 24 at each charging station, as indicated in process block 98. That is, controller 48 predicts the temperature that traction battery 24 will have at each charging station assuming that BEV 12 is driven from a current location to the charging station.

In further detail, based on the remaining distance, route metrics, vehicle loading conditions (vehicle gross train weight estimate, etc.), and expected powertrain operational conditions, the temperature of traction battery 24 is predicted for when BEV 12 arrives at each charging station. In this regard, known traction battery thermal models have been proven to be highly accurate. Blackbox variants of such traction battery thermal models can be created or simulated in the cloud or in-vehicle processing units and therefore would use minimal computational power. Simplified versions of these models can take simple inputs such as vehicle speed, combined vehicle weight, estimated future speed and grade, etc., to determine an expected traction battery current based on the expected torque and speed profile of the powertrain of BEV 12 to follow the given route.

The operation further includes controller 48 in conjunction with navigation system 60 learning the capabilities of each charging station, as indicated by process block 100. The capabilities of a charging station include the type of the charging station (e.g., Level 2 charger, fast charger, etc.) indicative of the charge rate of the charging station. Navigation system 60 via its transceiver 64 may use wireless communication (such as vehicle-to-infrastructure (V2I) communication) to communicate with charging stations or a charging station service provider thereof to determine the charger capability at each charging station. Navigation system 60 may further use such wireless communication to reserve a charging spot at a charging station at some time in the future when BEV 12 is expected to be at the location of this charging station assuming this charging station is scheduled for usage.

The operation further includes controller 48 estimating the charge rate that will be applicable to traction battery 24 when at each charging station, as indicated by process block 102. The estimation of the charge rate that will be applicable to traction battery 24 at a charging station takes into consideration the predicted temperature of the traction battery at the charging station. As described, the charge rate is the rate at which a charging station provides charge current to traction battery 24. The charge rate depends on the charge rate capability of the charging station (e.g., a fast charge charging station has a greater charge rate than a Level 2 charging station). The charge rate further depends on the temperature of traction battery 24 with the charge rate being substantially reduced at relatively cold temperatures of the traction battery (e.g., the unhindered charge rate of a Level 2 charging station charging a warm traction battery is greater than a substantially hindered charge rate of a fast charge charging station charging a sufficiently cold traction battery).

In estimating the charge rates that will be provided to traction battery 24 at each charge station, controller 48 assesses how the traction battery temperature and the thermal status of other related components on BEV 12 could affect the charge rate. When the current status of traction battery 24, BEV 12, and/or future route indicates that the traction battery will be charge limited once at a charging station, controller 48 may consider performance of further actions for warming the traction battery. On the other hand, when the charge and discharge capability if within of, for example, 10% of maximum capability, this feature can be turned off.

The operation further includes controller 48 estimating the SOC (i.e., SOCₛₜₐᵣₜ) that traction battery 24 will have at the beginning of charging and the SOC (i.e., SOC_{end}) that the traction battery is to have at the end of charging when at each charging station, as indicated by process block 104. The SOC that traction battery 24 is to have at the end of charging at a charging station is to be at least a SOC sufficient for BEV 12 to have enough range with given margin to drive to the next destination. Controller 48 may estimate the expected charge profile for the traction battery once at a charging station based on previously mapped data and look up tables for the predicted traction battery temperature in order to estimate the beginning SOC and the ending SOC for traction battery 24 at the charging station.

The operation further includes controller 48 estimating the charge amount for charging traction battery 24 when at each charging station, as indicated by process block 106. As noted, the charge amount is the amount of charge current provided to traction battery 24. As further noted, the charge amount depends on the difference between the SOC of traction battery 24 at the end of charging and the SOC of the traction battery at the beginning of charging. Thus, based on the beginning SOC and the ending SOC estimated by controller 48, the controller estimates the charge amount.

The operation further includes controller 48 estimating the charge time that will be spent for charging traction battery 24 when at each charging station, as indicated by process block 108. As noted, the charge time (or charge duration) is the time spent during which the traction battery is being charged at a charging station. As further noted, the charge time for charging traction battery 24 at a charging station is dependent on (i) the charge amount provided by the charging station to the traction battery and (ii) the charge rate at which the charging station provides the charge current to the traction battery. As such, controller 48 estimates the charge time that will be spent for charging traction battery 24 at a charging station based on the estimated charge amount to be provided by the charging station to the traction battery and the estimated charge rate at which the charging station will provide the charge current to the traction battery.

The operation further includes controller 48 estimating the drive time to and from each charging station, as indicated by process block 110. The drive time to a charging station is the time spent for BEV 12 to be driven from a current location to the charging station and from the charging station to a next destination. As such, more drive time is required for driving to a charging station that is located offset from the drive route than for a charging station that is located inline with the drive route.

The operation further includes controller 48 estimating the overall time of the vehicle trip for each of the charging stations, as indicated by process block 112. In its simplest form, the overall time of a vehicle trip is a summation of (i) the drive time for BEV 12 to be driven from the origin of the vehicle trip to a charging station, (ii) the charge time for traction battery 24 to be charged at the charging station, and (iii) the drive time for the BEV to be driven from the charging station to the destination of the vehicle trip. The simplest form thus pertains to only one charging station being utilized during the vehicle trip. A more complex form pertains to multiple charging stations being utilized during the vehicle trip. As such, in its more complex form, the overall time of a vehicle trip is a summation of (i) the drive time for BEV 12 to be driven from the origin to a first charging station, (ii) the charge time for traction battery 24 to be charged at the first charging station, (iii) the drive time for the BEV to be driven from the first charging station to a second charging station, (iv) the charge time for the traction battery to be charged at the second charging station, (v) the drive time for the BEV to be driven from the second charging station either to a third or more charging stations (with further charge time(s) and drive time(s)) or to the final destination.

For simplicity, it is assumed that only one charging event of traction battery 24 is required for BEV 12 to have enough range with given margin to complete the vehicle trip from the origin to the destination. As such, the simplest form of the overall time for the vehicle trip is assumed.

The operation further includes controller 48, in conjunction with navigation system 60, scheduling the charging station which implements the lowest overall time for the vehicle trip, as indicated by process block 114. Again, the charging station which implements the lowest overall time for the vehicle trip is the charging station in which a summation of the drive time spent driving from the origin to the charging station and from the charging station to the destination and the charge time spent charging at the charging station is lowest than such summation of drive time and charge time for each of the other charging stations. Controller 48 and navigation system 60 determine the appropriate vehicle route for BEV 12 to be driven to the scheduled charging station.

Of course, controller 48 can rank the estimated overall times for the vehicle trip for each of the charging stations and present the overall times with corresponding vehicle routes to the user for the user to make the final selection. In this case, the user may select that the charging station which implements, for example, the third lowest overall time for the vehicle trip be utilized (for instance, the additional time for utilizing this charging station compared to the lowest overall time is palatable to the user and the user prefers to drive along the corresponding vehicle route to this charging station and/or prefers this charging station).

Although not shown in flowchart 90, the operation may further include any of the following steps taken alone or in conjunction with any of the illustrated steps. Controller 48 can predict how the temperature of traction battery 24 will change throughout the vehicle trip based on usage of the traction battery. Controller 48 can then thereby determine whether traction battery 24 should not only be charged at a charging station but also be heated during the charge event so as to allow for a warm traction battery temperature throughout the rest of the vehicle trip. For example, BEV 12 can heat traction battery 24 substantially at the first charging station to allow the BEV to maintain discharge capabilities during the vehicle trip from the beginning. This can entail charging until a desired traction battery temperature is realized; maintaining traction battery temperature at other charging stations; perform conditioning while the traction battery is being charged; and allowing for faster charging at future stops.

Controller 48 can determine the number of additional charging events that are to occur throughout the vehicle trip. Controller 48 can make this determination based on the expected vehicle usage throughout the vehicle trip based on the distance of the route guidance system, user input, and/or vehicle previous usage. In turn, controller 48 can determine whether or not charging to a higher SOC or higher traction battery temperature would be advantageous for the vehicle user based on the total charge time and total expected vehicle usage. This should result in better utilization of BEV 12 throughout the vehicle trip, especially for those BEVs used in large, congested metropolitan environments (e.g., New York City) and with heavy usage (e.g., ride-hailing vehicles, taxi, etc.).

Controller 48 in conjunction with navigation system 60 can use the reference methods to perform trip planning to optimize route and charging station stops based on future charging estimates of the actual vehicle state. For example, when the traction battery is not warm enough at an earlier charging station, then a pre-programmed later charging station can be skipped.

As described, a control strategy for scheduling charging of a traction battery at a charging station during a vehicle trip which takes into consideration the temperature of the traction battery during the vehicle trip in order to minimize the overall time of the vehicle trip is provided. In this way, controller 48 implements the control strategy to solve the problem as to how to filter charging locations and dynamically assess the expected charge rate/charge time of the traction battery based on the thermal status of the vehicle (i.e., when the traction battery is cold).

An exemplary overview of the solution provided by the control strategy is as follows. With a cold traction battery temperature and the traction battery not having enough range for the vehicle to be driven to the final destination (e.g., the vehicle user's home), rather than route the vehicle to a nearby Level 1 or 2 charging station, controller 48 will recommend driving to a fast charger charging station that is further away than the Level 1 or 2 charging station (providing there is a fast charger charging station available and within range). This allows the traction battery to heat faster while the vehicle moves toward the final destination. To further increase traction battery temperature, the traction battery drain may be increased such as by heating the vehicle and/or the windshields, operating the rear defrosters, turning on heated chairs, etc., to allow the HVAC system of the vehicle to consume more current from the traction battery. This drain will more rapidly heat the traction battery with the vehicle then arriving at the fast charger charging station resulting in the overall trip time being significantly reduced.

Per the exemplary overview, the control strategy optimizes scheduling the initial charging at a charging station following departure of the vehicle from the origin of the vehicle trip. In scheduling the initial charging, the control strategy considers (i) how far away the location of the charging station is from the intended drive route (i.e., considers the additional drive time), (ii) the temperature of the traction battery when the vehicle arrives at the charging station, (iii) the SOC of the traction battery when the vehicle arrives at the charging station, and (iv) how long it will take (i.e., the charge time) for charging the traction battery at the charging station for the traction battery to have a desired SOC.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A vehicle comprising:
a battery; and
a controller configured to, in response to the battery having to be charged at a charging station during a trip for the battery to have sufficient energy for the vehicle to complete the trip, schedule the battery for charging during the trip at a selected charging station from among multiple charging stations in which an overall time of the trip will be lowest.

2. The vehicle of claim 1 wherein:
the controller detects that the overall time of the trip will be lowest with the battery being charged at the selected charging station based on a predicted temperature that the battery will have when being charged during the trip at the selected charging station.

3. The vehicle of claim 1 wherein:
the controller is further configured to, upon the battery being scheduled for charging during the trip at the selected charging station, implement a drive route for the vehicle to be driven to the selected charging station.

4. The vehicle of claim 1 wherein:
the selected charging station is closer to a destination of the trip than at least another charging station of the multiple charging stations.

5. The vehicle of claim 1 wherein:
the selected charging station has a charge rate capability lower than a charge rate capability of at least another charging station of the multiple charging stations.

6. The vehicle of claim 1 wherein:
a distance of an origin of the trip to the selected charging station to a destination of the trip is greater than a distance of the origin of the trip to at least another charging station of the multiple charging stations to the destination of the trip.

7. The vehicle of claim 1 wherein:
the controller detects the overall time of the trip that would exist with charging the battery during the trip at the selected charging station as being a summation of (i) a drive time for driving the vehicle from an origin of the trip to the selected charging station and from the selected charging station to a destination of the trip and (ii) a charge time for charging the battery during the trip at the selected charging station.

8. The vehicle of claim 7 wherein:
the controller is further configured to predict a temperature that the battery will have when being charged during the trip at the selected charging station;
the controller is further configured to estimate a charge rate at which the battery will be charged during the trip at the selected charging station based on the temperature that the battery will have when being charged during the trip at the selected charging station; and
the controller detects the charge time for charging the battery during the trip at the selected charging station based in part on the charge rate at which the battery will be charged during the trip at the selected charging station.

9. The vehicle of claim 8 wherein:
the controller is further configured to estimate a charge amount that the battery is to be charged with when being charged during the trip at the selected charging station, the charge amount being sufficient for the battery to have at least sufficient energy for the vehicle to be driven from the selected charging station to the destination; and
the controller detects the charge time for charging the battery during the trip at the selected charging station further based on the charge amount that the battery is to be charged with when being charged during the trip at the selected charging station.

10. The vehicle of claim 1 wherein:
the controller is further configured to estimate for each charging station the overall time of the trip that would exist with the battery being charged at that charging station to detect therefrom that the overall time of the trip is lowest with the battery being charged at the selected charging station.

11. The vehicle of claim 10 wherein:
the controller estimates for each charging station the overall time of the trip that would exist with the battery being charged at that charging station based on a predicted temperature that the battery would have when being charged during the trip at that charging station.

12. The vehicle of claim 10 wherein:
the controller estimates for each charging station the overall time of the trip that would exist with the battery being charged at that charging station as being a summation of (i) a drive time for driving the vehicle from an origin of the trip to that charging station and from the that charging station to a destination of the trip and (ii) a charge time for charging the battery during the trip at that charging station.

13. The vehicle of claim 12 wherein:
the controller is further configured to predict for each charging station a temperature that the battery would have when being charged during the trip at that charging station; and
the controller estimates for each charging station the charge time for charging the battery during the trip at that charging station based on the temperature that the battery would have when being charged during the trip at that charging station.

14. A system comprising:
a controller configured to, in response to a traction battery of a vehicle having to be charged at a charging station during a vehicle trip for the traction battery to have sufficient energy for the vehicle to complete the trip, schedule the traction battery for charging during the vehicle trip at a selected charging station from among multiple charging stations along one or more drive routes between an origin of the vehicle trip and a destination of the vehicle trip in which an overall time of the vehicle trip is the lowest, the overall time being a summation of (i) a drive time for the vehicle to be driven from the origin to the selected charging station to the destination and (ii) a charge time for the traction battery to be charged during the vehicle trip at the selected charging station.

15. The system of claim 14 wherein:
the controller detects that the overall time is lowest with the traction battery being charged at the selected charging station based on a predicted temperature that the traction battery will have when being charged during the vehicle trip at the selected charging station.

16. The system of claim 14 wherein:
a distance of an origin of the vehicle trip to the selected charging station to a destination of the vehicle trip is greater than a distance of the origin of the vehicle trip to at least another charging station of the multiple charging stations to the destination of the vehicle trip.

17. The system of claim 14 wherein:
the selected charging station is closer to a destination of the vehicle trip than at least another charging station of the multiple charging stations.

18. A method for a vehicle having a traction battery, the method comprising:
detecting that the traction battery will have to be charged at a charging station during a trip for the traction battery to have sufficient energy for the vehicle to complete the vehicle trip; and
scheduling the traction battery for charging during the vehicle trip at a selected charging station from among multiple charging stations in which an overall time of the vehicle trip is lowest.

19. The method of claim 18 further comprising:
predicting, for each charging station, a temperature that the traction battery will have when being charged during the vehicle trip at that charging station; and
detecting that the overall time of the vehicle trip is lowest with the traction battery being charged at the selected charging station based on the temperature that the traction battery will have when being charged during the vehicle trip at the selected charging station.

20. The method of claim 18 further comprising:
implementing a drive route for the vehicle to be driven to the selected charging station.
